(19) United States
(12) Patent Application Publication
(10) Pub. No.: US 2020/0412146 A1
(43) Pub. Date: Dec. 31, 2020

(54) BATTERY MONITORING METHOD, BATTERY MONITORING DEVICE, AND BATTERY MONITORING SYSTEM

(71) Applicant: SUMITOMO ELECTRIC INDUSTRIES, LTD., Osaka-shi, Osaka (JP)

(72) Inventor: Hiroaki TAKECHI, Osaka-shi (JP)

(73) Assignee: SUMITOMO ELECTRIC INDUSTRIES, LTD., Osaka-shi, Osaka (JP)

(21) Appl. No.: 16/971,142

(22) PCT Filed: Nov. 9, 2018
(86) PCT No.: PCT/JP2018/041609

§ 371 Date: Aug. 19, 2020

(30) Foreign Application Priority Data
Mar. 27, 2018 (JP) 2018-060817

(51) Int. Cl. H02J 7/00; H01M 10/44; H01M 10/48

(52) U.S. Cl. CPC H02J 7/0049; H01M 10/441; H01M 10/443; H01M 10/486; H01M 2220/20; H02J 7/0013; H02J 7/00032; H02J 7/005; H01M 10/482

(57) ABSTRACT

A battery monitoring device for a vehicle acquires a voltage, a current, and a temperature of each of a plurality of unit cells, and transmits unit cell information including the acquired voltage, current, and temperature of each unit cell and an identifier of each of the unit cells, to a state calculation device outside the vehicle and configured to calculate each of states of the plurality of unit cells. The state calculation device receives the unit cell information transmitted from the battery monitoring device, calculates each of the states of the plurality of unit cells on the basis of the received voltage, current, and temperature of each unit cell, and transmits calculated state information of each unit cell and the identifier of each of the unit cells to the battery monitoring device or an on-vehicle control device configured to perform control regarding charging/discharging of a secondary battery.

### TECHNICAL FIELD

The present disclosure relates to a battery monitoring method, a battery monitoring device, and a battery monitoring system.

The present application claims priority based on Japanese Patent Application No. 2018-60817 filed on Mar. 27, 2018, the entire contents of which are incorporated herein by reference.

### BACKGROUND ART

In recent years, vehicles such as hybrid electric vehicles (HEVs) and electric vehicles (EVs) are becoming prevalent. HEVs and EVs are equipped with secondary batteries. A secondary battery is a battery pack formed by connecting a plurality of unit cells in series-parallel. In such a vehicle, it is necessary to perform appropriate control corresponding to the state of the battery. For example, it is necessary to perform a cell balancing process, a charge/discharge stop process, a current limiting process, etc.

PATENT LITERATURE 1 discloses a battery monitoring device in which a voltage measurement unit for detecting the voltage of each battery module included in a secondary battery and serially transmitting the detected voltage to an ECU is provided to each battery module.

PATENT LITERATURE 2 discloses a battery monitoring system that detects the voltage of each unit cell included in a secondary battery and monitors the state of the secondary battery.

NON PATENT LITERATURES 1 and 2 disclose a technology to detect the voltage of each unit cell included in a secondary battery.

### CITATION LIST

### Patent Literature

PATENT LITERATURE 1: Japanese Laid-Open Patent Publication No. H8-339829
PATENT LITERATURE 2: Japanese Laid-Open Patent Publication No. 2016-15277

### Non Patent Literature

NON PATENT LITERATURE 1: “LTC6804-1/LTC6804-2 Multi-Cell Battery Monitor”, [online], Linear Technology Corporation, [Searched on Mar. 4, 2018], Internet (URL: http://cds.linear.com/docs/jp/datasheet/j680412f.pdf)
NON PATENT LITERATURE 2: Jun-ichi Kobayashi, “Wireless Connection of Battery Management System”, Journal of Society of Automotive Engineers of Japan, February 2018, Vol. 72, p. 61-66

### SUMMARY OF INVENTION

A battery monitoring method according to the present aspect is a battery monitoring method for monitoring each of a plurality of unit cells included in a secondary battery mounted on a vehicle, wherein a battery monitoring device provided to the vehicle acquires a voltage of each of the plurality of unit cells, acquires a current of the secondary battery, acquires a temperature of each of the plurality of unit cells, and transmits unit cell information including the acquired voltage, current, and temperature and an identifier of each of the unit cells, to a state calculation device provided outside the vehicle and configured to calculate each of states of the plurality of unit cells, and the state calculation device receives the unit cell information transmitted from the battery monitoring device, and calculates each of the states of the plurality of unit cells on the basis of the voltage, the current, and the temperature included in the received unit cell information.

A battery monitoring device according to the present aspect is a battery monitoring device configured to monitor each of a plurality of unit cells included in a secondary battery mounted on a vehicle, the battery monitoring device including: a voltage acquisition unit configured to acquire a voltage of each of the plurality of unit cells; a current acquisition unit configured to acquire a current of the secondary battery; a temperature acquisition unit configured to acquire a temperature of each of the plurality of unit cells; and a unit-cell-information transmission unit configured to transmit unit cell information including the voltage, the current, and the temperature acquired by the voltage acquisition unit, the current acquisition unit, and the temperature acquisition unit and an identifier of each of the unit cells, to a state calculation device configured to calculate each of states of the plurality of unit cells.

The present disclosure can be realized not only as a battery monitoring method or a battery monitoring device including such characteristic processing units, but can also be realized as a program for causing a computer to execute steps of such characteristic processes. In addition, the present disclosure can be realized as a semiconductor integrated circuit that realizes part or all of the battery monitoring device, or can be realized as another system including the battery monitoring device.

### BRIEF DESCRIPTION OF DRAWINGS

FIG. 1 is a block diagram showing an example of the configuration of a battery monitoring system according to Embodiment 1.

FIG. 2 is a block diagram showing an example of the configuration of a battery monitoring device according to Embodiment 1.

FIG. 3 is a block diagram showing an example of the functional configuration of a module control unit according to Embodiment 1.

FIG. 4 is a block diagram showing an example of the functional configuration of a unit-cell-state calculation device according to Embodiment 1.

FIG. 5A illustrates an equivalent circuit model of a unit cell.

FIG. 5B illustrates an equivalent circuit model of the unit cell.

FIG. 5C illustrates an equivalent circuit model of the unit cell.

FIG. 6 is a conceptual diagram showing an example of state information of the unit cell stored in a battery state storage unit.

FIG. 7 is a perspective view showing battery monitoring devices and a secondary battery formed by connecting battery module devices according to Embodiment 1 in series.

FIG. 8 is a perspective view showing an example of the configuration of the battery module device according to Embodiment 1

FIG. 9 is a plan view showing an example of the configuration of the battery module device according to Embodiment 1.

FIG. 10 is a flowchart showing a processing procedure regarding monitoring of unit cells according to Embodiment 1.

FIG. 11 is a flowchart showing a processing procedure regarding monitoring of the unit cells according to Embodiment 1.

FIG. 12 is a flowchart showing a processing procedure regarding output and deletion of cell state information.

### DESCRIPTION OF EMBODIMENTS

### Problems to be Solved by the Present Disclosure

In PATENT LITERATURES 1 and 2, the battery monitoring device monitors the voltage of each unit cell included in the secondary battery, but does not accurately grasp the state of each unit cell. Thus, there is a technical problem that the state of each unit cell cannot be accurately grasped and appropriate control corresponding to the state of each unit cell cannot be performed.

An object of the present disclosure is to provide a battery monitoring method, a battery monitoring device, and a battery monitoring system that allow the state of each unit cell included in a secondary battery, which is a battery pack, to be grasped.

### Effects of the Present Disclosure

According to the present disclosure, it is possible to provide a battery monitoring method, a battery monitoring device, and a battery monitoring system that allow the state of each unit cell included in a secondary battery, which is a battery pack, to be grasped.

### DESCRIPTION OF EMBODIMENT OF THE PRESENT DISCLOSURE

First, embodiments of the present disclosure are listed and described. At least some parts of the embodiments described below may be combined as desired.

(1) A battery monitoring method according to the present aspect is a battery monitoring method for monitoring each of a plurality of unit cells included in a secondary battery mounted on a vehicle, wherein a battery monitoring device provided to the vehicle acquires a voltage of each of the plurality of unit cells, acquires a current of the secondary battery, acquires a temperature of each of the plurality of unit cells, and transmits unit cell information including the acquired voltage, current, and temperature and an identifier of each of the unit cells, to a state calculation device provided outside the vehicle and configured to calculate each of states of the plurality of unit cells, and the state calculation device receives the unit cell information transmitted from the battery monitoring device, and calculates each of the states of the plurality of unit cells on the basis of the voltage, the current, and the temperature included in the received unit cell information.

(2) A battery monitoring device according to the present aspect is a battery monitoring device configured to monitor each of a plurality of unit cells included in a secondary battery mounted on a vehicle, the battery monitoring device including: a voltage acquisition unit configured to acquire a voltage of each of the plurality of unit cells; a current acquisition unit configured to acquire a current of the secondary battery; a temperature acquisition unit configured to acquire a temperature of each of the plurality of unit cells; and a unit-cell-information transmission unit configured to transmit unit cell information including the voltage, the current, and the temperature acquired by the voltage acquisition unit, the current acquisition unit, and the temperature acquisition unit and an identifier of each of the unit cells, to a state calculation device configured to calculate each of states of the plurality of unit cells.

(3) Preferably, the current acquisition unit acquires the current of the secondary battery by receiving current information wirelessly transmitted from a current detection unit provided to the secondary battery.

(4) A battery monitoring system according to the present aspect includes: the battery monitoring device according to the aspect (2) or (3) configured to monitor each of the plurality of unit cells of the secondary battery mounted on the vehicle; and the state calculation device provided outside the vehicle and configured to calculate each of the states of the plurality of unit cells, and the state calculation device includes a unit-cell-information reception unit configured to receive the unit cell information transmitted from the battery monitoring device, and a state calculation unit configured to calculate each of the states of the plurality of unit cells on the basis of the voltage, the current, and the temperature included in the unit cell information received by the unit-cell-information reception unit.

In the aspects (1), (2), and (4), in the battery monitoring method, the state of each of the plurality of unit cells included in the secondary battery is calculated. Specifically, the battery monitoring device acquires the voltage and the temperature of each of the plurality of unit cells. In addition, the battery monitoring device acquires the current of the secondary battery. The current is the common current flowing through the plurality of unit cells to be monitored. Regarding the temperature, the number of locations where the temperature is detected is not particularly limited as long as the state of each unit cell to be monitored can be grasped with required accuracy. In the case of monitoring ten unit cells, temperature sensors may be disposed at two locations, and detection results of the two temperature sensors may be acquired as the temperature of each unit cell. That is, the temperature detected by the first temperature sensor may be acquired as information indicating the temperature of each of five unit cells, and the temperature detected by the second temperature sensor may be acquired as information indicating the temperature of each of the other five unit cells. Similarly, temperature sensors may be disposed at three or more locations to monitor the temperature of each unit cell, or temperature sensors may be disposed at all the unit cells to detect the temperatures of the respective unit cells. The unit cell information including the voltage, the current, and the temperature of each unit cell detected as described above and the identifier of each of the unit cells is transmitted from the battery monitoring device to the state calculation device, and the state of each unit cell is calculated.

In the aspect (3), current information wirelessly transmitted from the current detection unit provided at an appropriate location in the secondary battery can be acquired. Therefore, a signal line connecting the battery monitoring device and the current detection unit is unnecessary.

For example, in the case where the number of unit cells included in the secondary battery is large and a plurality of battery monitoring devices are provided, the distance for which a signal line is extended becomes long, and thus a reduction in workability during assembly becomes a problem. In addition, when the signal line becomes long, it is necessary to develop a technology for ensuring reliability against noise.

According to the present aspect, since a signal line for transmitting and receiving current information is eliminated, work for assembling the secondary battery and the monitoring device can be simplified, and reliability against noise can be ensured.

(5) Preferably, the state calculation device includes a state information transmission unit configured to transmit state information of each of the plurality of unit cells calculated by the state calculation unit and the identifier of each of the unit cells, to the battery monitoring device or an on-vehicle control device configured to perform control regarding charging/discharging of the secondary battery.

According to the present aspect, the state calculation device receives the received unit cell information and calculates the state of each unit cell on the basis of the information of the voltage, the current, and the temperature of each unit cell included in the unit cell information. The state calculation device transmits state information indicating the calculated state of each unit cell, to the on-vehicle control device or the battery monitoring device.

(6) Preferably, the on-vehicle control device includes a vehicle-outside wireless communication unit configured to perform wireless communication with the state calculation device provided outside the vehicle, and the battery monitoring device transmits the unit cell information via the on-vehicle control device to the state calculation device.

In the present aspect, each monitoring device can transmit the unit cell information via the on-vehicle control device to the state calculation device. Therefore, even in the case where a plurality of monitoring devices configured to monitor a plurality of unit cells are included, each of the plurality of monitoring devices does not need to perform wireless communication with the state calculation device.

(7) Preferably, the battery monitoring device wirelessly transmits the unit cell information of each of the plurality of unit cells to the on-vehicle control device, and transmits the unit cell information via the on-vehicle control device to the state calculation device.

In the present aspect, the battery monitoring device can wirelessly transmit the unit cell information indicating the voltage, the current, etc., of each unit cell included in the secondary battery. Therefore, a communication line connecting the battery monitoring device and the on-vehicle control device is unnecessary.

For example, in the case where the number of unit cells included in the secondary battery is large and a plurality of battery monitoring devices are provided, the distance for which a communication line is extended becomes long, and thus a reduction in workability during assembly becomes a problem. In addition, when the communication line becomes long, it is necessary to develop a technology for ensuring reliability against noise.

According to the present aspect, since a communication line is eliminated, work for assembling the secondary battery and the monitoring device can be simplified, and reliability against noise can be ensured.

(8) Preferably, the battery monitoring device includes: a state information reception unit configured to receive the state information and the identifier transmitted from the state calculation device; and a battery state storage unit configured to store the state information received by the state information reception unit and the identifier of each of the unit cells in association with each other.

In the present aspect, the battery state storage unit stores the state information of each unit cell included in the secondary battery and the identifier of each unit cell in association with each other. Therefore, the state of each unit cell included in the secondary battery can be grasped by merely reading the state information and the identifier from the battery state storage unit. For example, in the case of disassembling the secondary battery into the unit cells and reusing each unit cell, it is necessary to grasp the state of each unit cell. In this case, a worker can easily grasp the cell state of each unit cell by merely reading the state information and the identifier from the battery state storage unit of the battery monitoring device. It is not necessary to check the state of each unit cell, and the unit cells can be reused efficiently.

(9) Preferably, a deletion processing unit configured to delete the state information and the identifier stored in the battery state storage unit is included.

In the present aspect, the battery state monitoring device can delete the state information and the identifier stored in the battery state storage unit, as necessary. For example, when the unit cells to be monitored are changed through battery replacement, the information in the battery state storage unit can be deleted, and state information and identifiers of new unit cells to be monitored can be stored in the battery state storage unit.

(10) Preferably, the state information calculation unit calculates at least one of a full charge capacity, a state of charge, a state of health, and a cell equivalent circuit parameter of each of the plurality of unit cells.

In the present aspect, the full charge capacity, the state of charge, the state of health, the cell equivalent circuit parameter, etc., of each unit cell can be grasped. Charging/discharging of the secondary battery can be more appropriately controlled by grasping these states of each unit cell.

(11) Preferably, the state calculation device transmits state information of each of the plurality of unit cells calculated by the state calculation unit or information indicating a state of the secondary battery based on the state information of each of the plurality of unit cells, to a user terminal device.

In the present aspect, the state information such as the full charge capacity, the state of charge, the state of health, and the cell equivalent circuit parameter of each unit cell can be notified to the user.

### Detailed Description of Embodiments of the Present Disclosure

Specific examples of a battery monitoring method, a battery monitoring device, and a battery monitoring system according to an embodiment of the present disclosure will be described below with reference to the drawings. The present disclosure is not limited to these examples and is indicated by the claims, and is intended to include meaning equivalent to the claims and all modifications within the scope of the claims.

### Embodiment 1

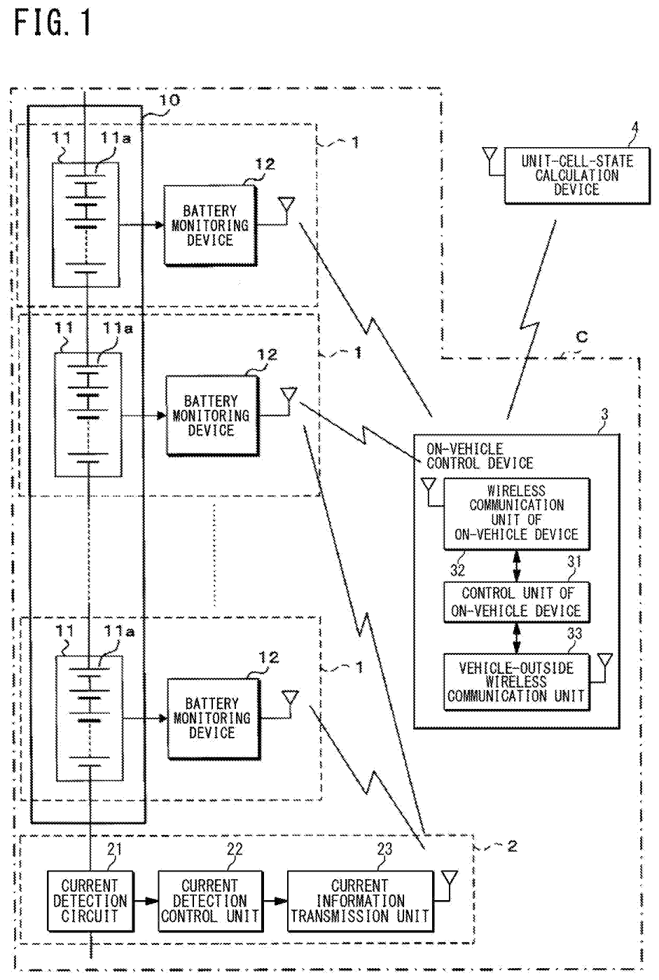

FIG. 1 is a block diagram showing an example of the configuration of a battery monitoring system according to Embodiment 1. The battery monitoring system according to Embodiment 1 includes a plurality of battery module devices 1 forming a secondary battery 10 mounted on a vehicle C, a current detection device 2, an on-vehicle control device 3, and a unit-cell-state calculation device 4 installed outside the vehicle. The secondary battery 10 is, for example, a lithium-ion battery, a nickel-hydrogen battery, or the like formed by connecting a plurality of unit cells 11a in series. The lithium-ion battery and the nickel-hydrogen battery are examples of the secondary battery 10, and the types and output voltages thereof are not particularly limited.

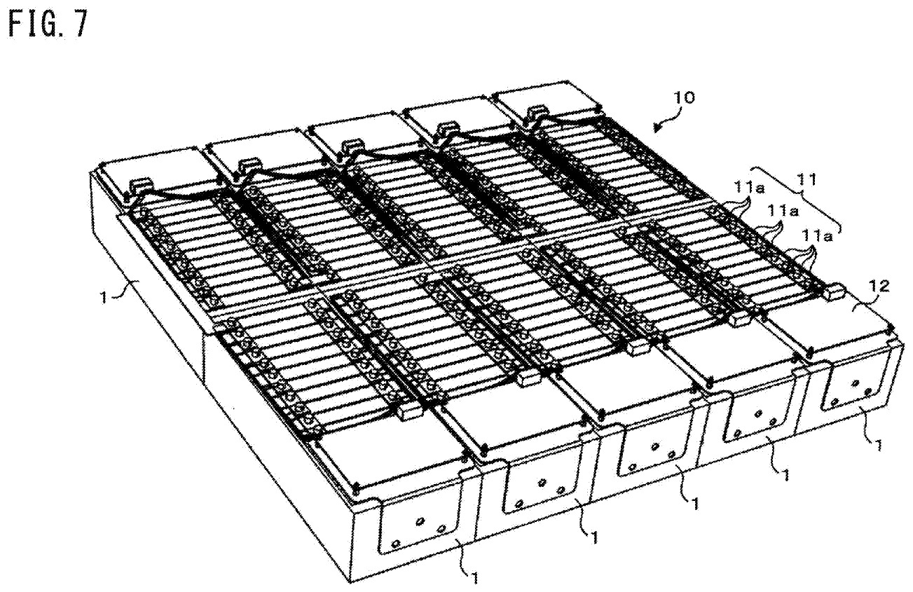

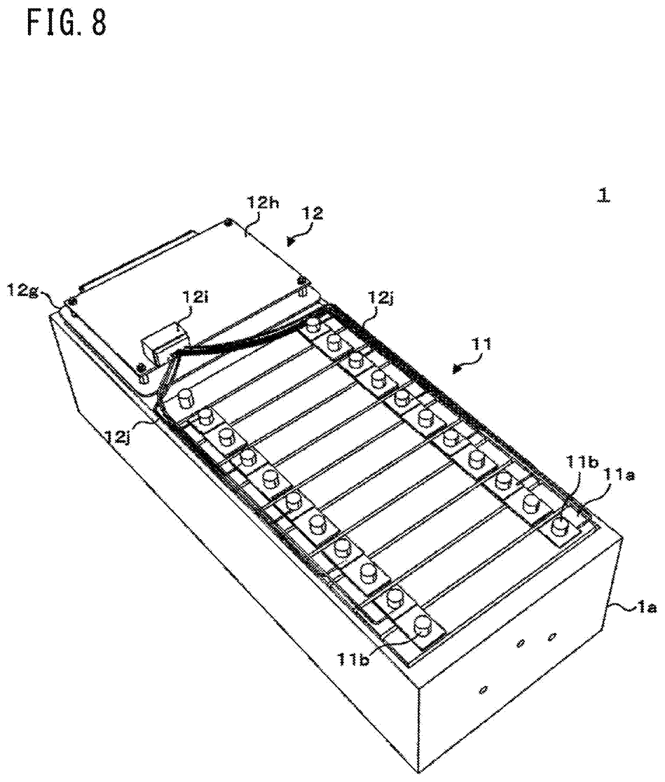

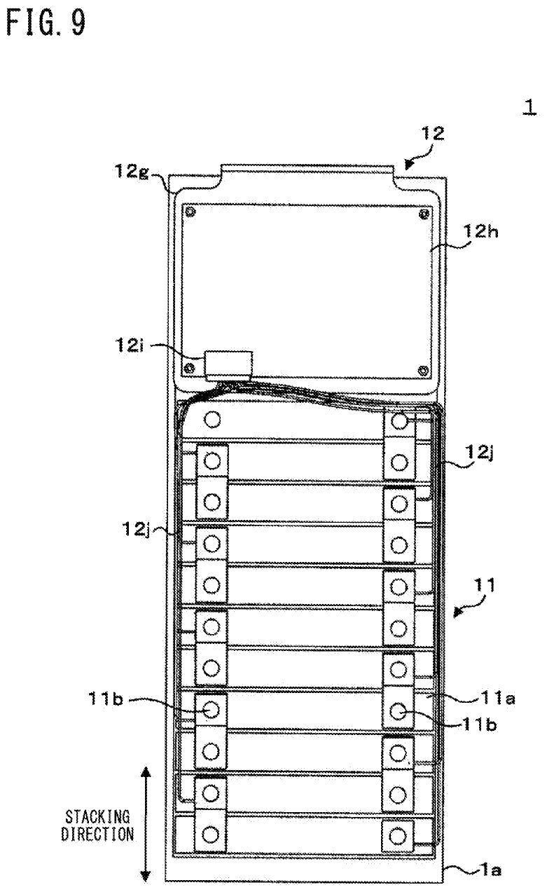

Each battery module device 1 includes a battery module 11 formed by connecting a plurality of unit cells 11a in series and forming a part of the secondary battery 10, and a battery monitoring device 12 that monitors the state of the battery module 11. The battery monitoring device 12 monitors the voltage, the current, and the temperature of each of the plurality of unit cells 11a included in the battery module 11 to be monitored, and wirelessly transmits unit cell information including the detected voltage, current, and temperature of each unit cell 11a and a cell ID for identifying the unit cell 11a, to the on-vehicle control device 3. The battery module 11 and the battery monitoring device 12 are unitized (see FIG. 8 and FIG. 9). The secondary battery 10 is formed by connecting the battery modules 11 of the plurality of battery module devices 1 in series. For example, the secondary battery 10 is formed by connecting ten battery modules 11 each including eleven unit cells 11a in series (see FIG. 7). That is, the secondary battery 10 includes 11×10=110 unit cells 11a.

The current detection device 2 includes a current detection circuit 21 that detects currents such as a charge current and a discharge current flowing through the secondary battery 10, a current detection control unit 22, and a current information transmission unit 23.

The current detection circuit 21 includes, for example, a shunt resistor for detecting the current of the secondary battery 10. The shunt resistor is connected in series to the secondary battery 10. The current detection circuit 21 detects the voltage between both ends of the shunt resistor. The current detection control unit 22 converts the voltage between both ends of the shunt resistor into a current, and wirelessly transmits information indicating the current of the secondary battery 10, to the plurality of battery monitoring devices 12 via the current information transmission unit 23. Since the battery modules 11 are connected in series and the unit cells 11a are connected in series, the current flowing through each unit cell 11a can be indirectly detected by detecting a current at one end side of the secondary battery 10.

The configuration including the shunt resistor is an example of the current detection circuit 21, and a known current sensor can be used. For example, a current can be detected using a Hall element.

The on-vehicle control device 3 includes a control unit 31 of an on-vehicle device, a wireless communication unit 32 of the on-vehicle device, and a vehicle-outside wireless communication unit 33.

The wireless communication unit 32 of the on-vehicle device is a communication circuit that transmits and receives various kinds of information required for monitoring the states of the secondary battery 10 and the unit cells 11a, to and from the plurality of battery module devices 1.

The vehicle-outside wireless communication unit 33 is a communication circuit that transmits and receives various kinds of information required for monitoring the states of the unit cells 11a, to and from the unit-cell-state calculation device 4.

The control unit 31 of the on-vehicle device performs wireless communication with each of the battery monitoring devices 12 of the plurality of battery module devices 1 via the wireless communication unit 32 of the on-vehicle device and monitors the states of the secondary battery 10 and the unit cells 11a. Specifically, the wireless communication unit 32 of the on-vehicle device manages the timing to monitor the state of the secondary battery 10, and transmits request information for requesting the unit cell information of the unit cells 11a included in the secondary battery 10, to the respective battery modules 11 at a required timing. The control unit 31 of the on-vehicle device receives the unit cell information transmitted from each battery module 11 in response to the request, by the wireless communication unit 32 of the on-vehicle device. The unit cell information includes the voltage, the current, the temperature, and the cell ID of each unit cell 11a.

Next, the control unit 31 of the on-vehicle device transmits the unit cell information via the vehicle-outside wireless communication unit 33 to the unit-cell-state calculation device 4, and requests a process of calculating the cell state of each unit cell 11a and cell state information that is a calculation result. The control unit 31 of the on-vehicle device grasps the states of the secondary battery 10 and the unit cells 11a on the basis of the cell state information calculated by the unit-cell-state calculation device 4, and performs control regarding charging/discharging of the secondary battery 10. For example, when the unit cell 11a is in a state of over-discharge and over-charge, or when occurrence of over-current is detected, the control unit 31 of the on-vehicle device executes a process of stopping charging/discharging. In addition, the control unit 31 of the on-vehicle device determines whether or not there is a variation in the charge capacity of each unit cell 11a, and executes a process for ensuring cell balance. For example, the control unit 31 of the on-vehicle device ensures cell balance by performing transfer of charge energy between the unit cells 11a or forcibly discharging the unit cells 11a.

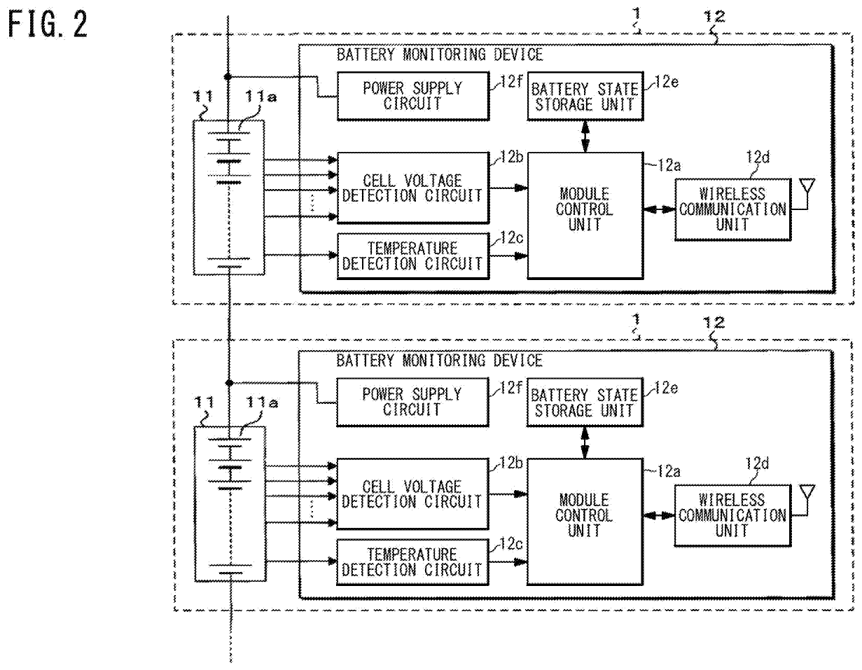

FIG. 2 is a block diagram showing an example of the configuration of the battery monitoring device 12 according to Embodiment 1. The plurality of battery module devices 1 have the same configuration, and thus the configuration of one battery module device 1 will be described.

The battery monitoring device 12 includes a module control unit 12a that controls operation of the entire battery monitoring device 12, a cell voltage detection circuit 12b, a temperature detection circuit 12c, a wireless communication unit 12d, a battery state storage unit 12e, and a power supply circuit 12f.

The cell voltage detection circuit 12b detects the voltage of each of the plurality of unit cells 11a included in the battery module 11, and outputs information indicating the voltage of each unit cell 11a, to the module control unit 12a. For example, in the case where the battery module 11 includes eleven unit cells 11a, the cell battery detection circuit detects the voltage between both ends of each of the eleven unit cells 11a.

The temperature detection circuit 12c detects the temperature of each of the plurality of unit cells 11a included in the battery module 11, and outputs information indicating the temperature, to the module control unit 12a. The temperature detection circuit 12c includes, for example, a thermistor. The thermistor of the temperature detection circuit 12c is disposed at a predetermined location in the secondary battery 10. The temperature detection circuit 12c detects the voltage between both ends of the thermistor, converts the detected voltage between both ends into a temperature, and outputs information indicating the temperature, to the module control unit 12a. The configuration including the thermistor is an example of the temperature detection circuit 12c, and a known temperature sensor can be used. For example, a temperature can be detected using a temperature-measuring resistor, a semiconductor temperature sensor, a thermocouple, or the like.

The temperature sensor does not necessarily have to be disposed at each of the unit cells 11a, and if the temperature of each unit cell 11a can be detected, a detection value of one temperature sensor can be handled as information indicating the temperature of each of the plurality of unit cells 11a.

The wireless communication unit 12d is a communication circuit that wirelessly transmits and receives various kinds of information required for monitoring the secondary battery 10 and the battery modules 11, to and from the current detection device 2 and the on-vehicle control device 3.

The module control unit 12a is composed of a microcomputer having a central processing unit (CPU), a read only memory (ROM), a random access memory (RAM), a time measuring unit, an input/output interface, etc., a field-programmable gate array (FPGA), or the like. The cell voltage detection circuit 12b, the temperature detection circuit 12c, the wireless communication unit 12d, and the battery state storage unit 12e are connected to the input/output interface of the module control unit 12a. The module control unit 12a acquires the information that is outputted from the cell voltage detection circuit 12b and that indicates the voltage of each unit cell 11a, the information that is outputted from the temperature detection circuit 12c and that indicates the temperature, and the information that is received by the wireless communication unit 12d and that indicates the currents flowing through the secondary battery 10 and the unit cells 11a. The module control unit 12a wirelessly transmits unit cell information including the acquired voltage, temperature, and current of each unit cell 11a and the cell ID of the unit cell 11a, via the on-vehicle control device 3 to the unit-cell-state calculation device 4.

The battery state storage unit 12e is a non-volatile memory such as an electrically erasable programmable ROM (EEPROM) and a flash memory. The battery state storage unit 12e stores therein state information of each unit cell 11a calculated by the unit-cell-state calculation device 4 and the cell ID for identifying the unit cell 11a in association with each other.

The power supply circuit 12f converts power supplied from the secondary battery 10 into a voltage suitable for driving the battery monitoring device 12 and supplies the power to each component of the battery monitoring device 12.

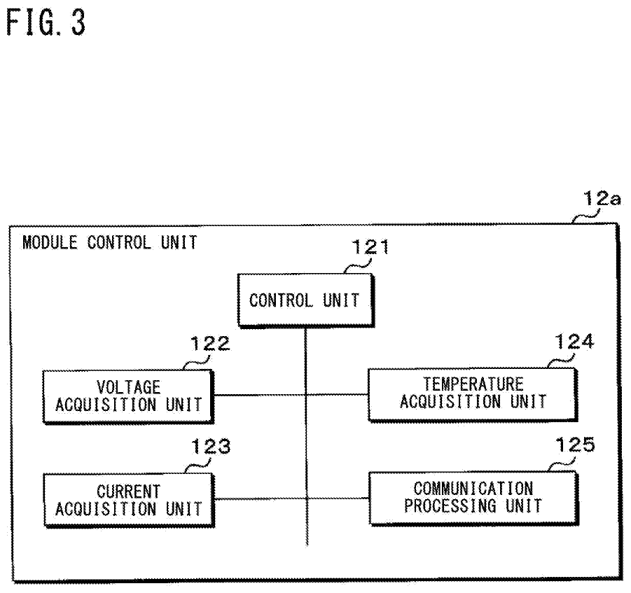

FIG. 3 is a block diagram showing an example of the functional configuration of the module control unit 12a according to Embodiment 1. The module control unit 12a includes a control unit 121 that controls the entire device, a voltage acquisition unit 122, a current acquisition unit 123, a temperature acquisition unit 124, and a communication processing unit 125.

The voltage acquisition unit 122 acquires the voltage information outputted from the cell voltage detection circuit 12b, as a voltage between electrode terminals 11b (see FIG. 8) of each of the plurality of unit cells 11a. In particular, the voltage acquisition unit 122 can acquire the open-circuit voltage of the unit cell 11a by acquiring the voltage between the electrode terminals 11b of the unit cell 11a when a starting switch, of the vehicle C, which is not shown, is in an OFF state and charging/discharging for cell balancing and the like is not performed. When the on-vehicle control device 3 controls charging/discharging of the secondary battery 10 and monitors the ON/OFF state of the starting switch, the battery monitoring device 12 can recognize the ON/OFF state of the starting switch, etc., by performing communication with the on-vehicle control device 3.

The current acquisition unit 123 acquires the information of the current (charge current and discharge current) of the secondary battery 10 received by the wireless communication unit 12d, as the current of each unit cell 11a.

The temperature acquisition unit 124 acquires the temperature information outputted from the temperature detection circuit 12c, as the temperature of each unit cell 11a.

The control unit 121 can control the sampling cycle for acquiring the voltage and the current. The sampling cycle can be, for example, 10 milliseconds, but is not limited thereto.

The communication processing unit 125 controls communication performed with the control unit 31 of the on-vehicle device, and executes a process of acquiring information transmitted from the on-vehicle control device 3. The module control unit 12a can recognize the ON/OFF state of the starting switch, of the vehicle C, which is not shown, etc., by performing communication with the on-vehicle control device 3.

Moreover, the communication processing unit 125 executes a process of: adding, to the unit cell information including the acquired voltage, current, temperature, and cell ID of each unit cell 11a acquired in accordance with processing of the module control unit 12a, a module ID for identifying the battery monitoring device 12 that includes the module control unit 12a; and transmitting the unit cell information to the on-vehicle control device 3.

When the battery module 11 is abnormal, by notifying the on-vehicle control device 3 of the abnormality such as over-current, it is possible to open a cut-off relay (not shown) and stop charging and discharging of the secondary battery 10.

The on-vehicle control device 3 periodically requests information of the voltage, the current, the temperature, etc., of each unit cell 11a from each battery monitoring device 12 in a first cycle, and each battery monitoring device 12 transmits the unit cell information of each unit cell 11a to the on-vehicle control device 3 in response to the request. The on-vehicle control device 3 adds an on-vehicle device ID for identifying the on-vehicle control device 3, to the unit cell information collected from the plurality of battery monitoring devices 12, and periodically transmits the unit cell information to the unit-cell-state calculation device 4 in a second cycle.

The unit-cell-state calculation device 4 is composed of a microcomputer having a central processing unit (CPU), a read only memory (ROM), a random access memory (RAM), a time measuring unit, an input/output interface, etc., a Large-Scale Integration (LSI) dedicated for detecting the state of each unit cell 11a, a field-programmable gate array (FPGA), or the like. The unit-cell-state calculation device 4 receives the unit cell information transmitted from the on-vehicle control device 3. The unit-cell-state calculation device 4 calculates the state of each unit cell 11a on the basis of the information of the voltage, the temperature, and the current included in the received unit cell information. For example, the unit-cell-state calculation device 4 calculates the full charge capacity (FCC), the state of charge (SOC), the state of health (SOH), and a cell equivalent circuit parameter of each unit cell 11a. The unit-cell-state calculation device 4 transmits state information indicating the calculated state of each unit cell 11a, to the on-vehicle control device 3. The specific function of the unit-cell-state calculation device 4 and various processing procedures will be described later.

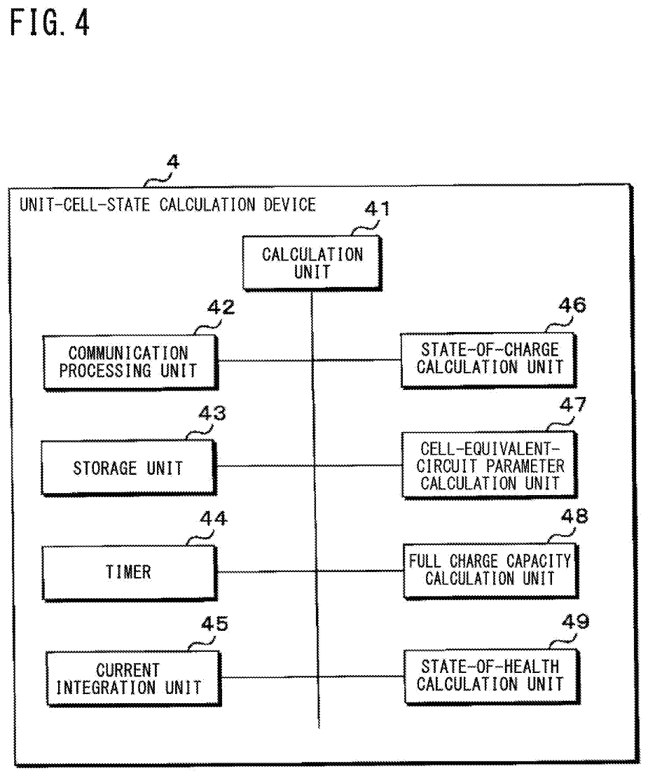

FIG. 4 is a block diagram showing an example of the functional configuration of the unit-cell-state calculation device 4 according to Embodiment 1. The unit-cell-state calculation device 4 includes a calculation unit 41 that controls the entire device, a communication processing unit 42, a storage unit 43, a timer 44, a current integration unit 45, a state-of-charge calculation unit 46, a cell-equivalent-circuit parameter calculation unit 47, a full-charge-capacity calculation unit 48, and a state-of-health calculation unit 49.

The communication processing unit 42 controls communication performed with the on-vehicle control device 3, and executes a process of acquiring the unit cell information transmitted from the on-vehicle control device 3. In the unit cell information, the module ID and the on-vehicle device ID are added. Thus, the calculation unit 41 can recognize that the unit cell information is information of which module mounted on which vehicle C.

Moreover, the communication processing unit 42 executes a process of transmitting the state information obtained through calculation by the unit-cell-state calculation device 4, etc., to the on-vehicle control device 3.

The storage unit 43 has stored therein a correlation between the open-circuit voltage and the state of charge of each unit cell 11a as information for calculating the state of charge of each of the plurality of unit cells 11a. The state of charge of each unit cell 11a tends to increase as the open-circuit voltage of each unit cell 11a increases. The correlation changes depending on the temperature and the state of health, and thus a correlation may be stored for each of a plurality of temperatures and states of health.

Moreover, the storage unit 43 has stored therein the initial full charge capacity or cell equivalent circuit parameter of each of the plurality of unit cells 11a as information for calculating the state of health of each unit cell 11a. The relationship between an increase rate of internal resistance and a discharge capacity ratio corresponding to a state of health may be stored as information for calculating the state of health of each unit cell 11a. Generally, as the internal resistance increase rate increases, the discharge capacity ratio decreases. That is, the state of health deteriorates.

The timer 44 outputs a time measurement result to the calculation unit 41. The timer 44 measures the date and time when the state information of each unit cell 11a is calculated.

The current integration unit 45 integrates, for each unit cell 11a, the current acquired from the unit cell 11a. The integrated value of the current is obtained by integrating the current over time, and corresponds to an amount of change in charge amount. The integrated value of the current is positive in the case of charging, and is negative in the case of discharging. The integrated value in a certain period can be positive or negative depending on the magnitude of the values of charge current and discharge current in this period. The timing when integration is started is the timing when the secondary battery 10 or the battery monitoring device 12 itself is started, and the current integration unit 45 continuously calculates an integrated value. The integrated value may be reset at a predetermined timing.

The state-of-charge calculation unit 46 calculates the state of charge of each unit cell 11a on the basis of the open-circuit voltage of each unit cell 11a and the correlation between the open-circuit voltage and the state of charge stored in the storage unit 43. In addition, the state-of-charge calculation unit 46 may calculate the state of charge with the state of charge at a specific time as a reference on the basis of a charge current and a discharge current obtained through integration by the current integration unit 45, and a later-described full charge capacity. When charging is completed and the secondary battery 10 is fully charged, SOC in may be set to 100%.

The cell-equivalent-circuit parameter calculation unit 47 calculates values of a resistor and a capacitor (hereinafter, these values of the resistor and the capacitor are referred to as internal parameters or cell equivalent circuit parameters) representing an equivalent circuit model of the unit cell 11a.

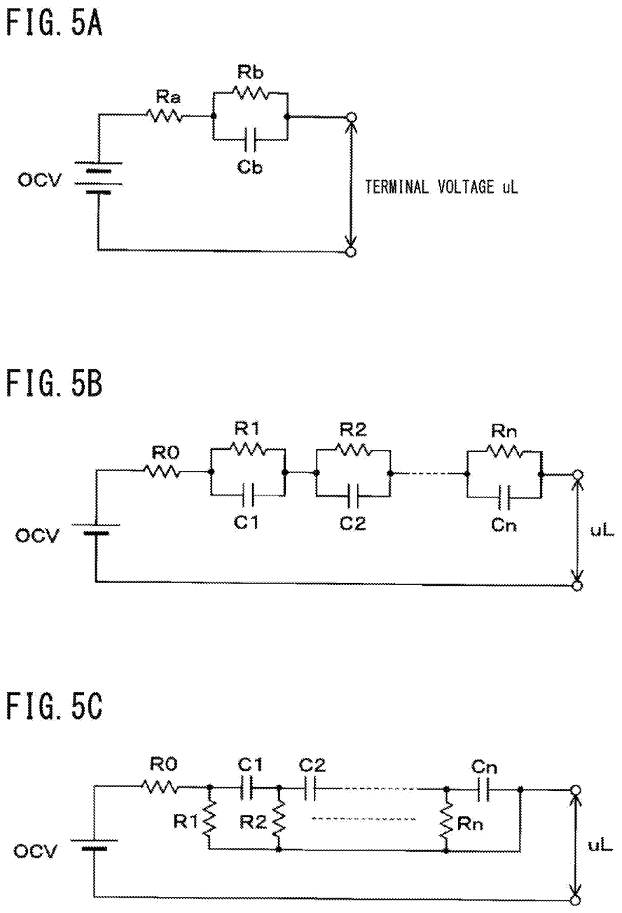

FIG. 5A, FIG. 5B, and FIG. 5C each illustrate an equivalent circuit model of the unit cell 11a. FIG. 5A illustrates an equivalent circuit model of the unit cell 11a according to the present embodiment. The equivalent circuit model is represented by a circuit in which a resistor Ra and a parallel circuit of a resistor Rb and a capacitor Cb are connected in series to a voltage source having OCV as an electromotive force. The resistor Ra corresponds to electrolyte resistance. The resistor Rb corresponds to charge transfer resistance, and the capacitor Cb corresponds to electric double layer capacitance. The resistor Ra may include charge transfer resistance, and the resistor Rb may correspond to diffusion resistance.

The equivalent circuit model of the unit cell 11a is not limited to the model shown in FIG. 5A. For example, the equivalent circuit model of the unit cell 11a may be an n-th order (n is a natural number) Foster type RC ladder circuit represented by approximation with the sum of infinite series, in which n parallel circuits of a resistor Rj and a capacitor Cj (j=1, 2, . . . , n) are connected in series to a resistor RO as shown in FIG. 5B, or may be an n-th order Cowell type RC ladder circuit in which ends of n resistors Rj (j=1, 2, . . . , n) are connected to each other and the other ends of the n resistors Rj are connected between n capacitors Cj connected in series as shown in FIG. 5C.

For the internal parameters of the equivalent circuit model shown in FIG. 5A, it is known that the following approximate equations (1) to (4) are established (for the details, see “Battery Management System Engineering”, Shuichi Adachi et al., Tokyo Denki University Press, Chapter 6.2.2).

uL(k)=b0·i(k)+b1·i(k−1)−a1·uL(k−1)+(1+a1)·OCV (1)

b0=Ra (2)

b1=Ts·Ra/(Rb·Cb)+Ts/Cb−Ra (3)

a1=Ts/(RbCb)−1 (4)

wherein

uL: acquired voltage

i: acquired current

Ts: cycle for acquiring

When the internal parameters Ra, Rb, and Cb are back-calculated from the above equations (2) to (4), the following equations (5) to (7) are established.

Ra=b0 (5)

Rb=(b1-a1·b0)/(1+a1) (6)

Cb=Ts/(b1−a1·b0) (7)

In the present embodiment, the successive least squares method is applied to the equation (1) to determine coefficients b0, b1, and a1, and the determined coefficients are substituted into the equations (5) to (7) to estimate the internal parameters Ra, Rb, and Cb. It is assumed that the OCV is constant while each internal parameter is estimated once. The estimated internal parameters may be corrected in accordance with the temperature acquired by the temperature acquisition unit 124.

It is also possible to calculate the internal parameters Ra, Rb, and Cb using a Kalman filter. Specifically, an observation vector when an input signal represented by a terminal voltage and current is given to the unit cell 11a and a state vector when the same input signal as described above is given to the equivalent circuit model of the unit cell 11a are compared, the difference between these vectors is multiplied by the Kalman gain, and the resultant value is fed back to the equivalent circuit model, whereby correction of the equivalent circuit model is repeated such that the difference between both vectors is minimized. Accordingly, the internal parameters are estimated.

The full-charge-capacity calculation unit 48 calculates a unit full charge amount of each of the plurality of unit cells 11a. Upon calculating a full charge capacity, the state-of-charge calculation unit 46 calculates a first state of charge on the basis of a first open-circuit voltage acquired by the voltage acquisition unit 122 at a first time at which the starting switch is in an OFF state in a first trip period from a turn-on time of the starting switch related to charging/discharging operation of the secondary battery 10 to the next turn-on time thereof. A trip indicates a period from a time at which the starting switch is turned on to a time at which the starting switch is turned on next after the starting switch is turned off once. The voltage acquisition unit 122 of the battery monitoring device 12 acquires the first open-circuit voltage of each unit cell 11a at the first time. The state of charge can be calculated from the open-circuit voltage on the basis of the predetermined correlation between the open-circuit voltage and the state of charge of the unit cell 11a.

Moreover, the state-of-charge calculation unit 46 calculates a second state of charge on the basis of a second open-circuit voltage acquired by the voltage acquisition unit 122 at a second time at which the starting switch is in an OFF state in a second trip period that is a trip period next to the first trip period. The first state of charge is represented as SOC1, and the second state of charge is represented as SOC2.

The current integration unit 45 calculates a charge/discharge amount of the secondary battery 10 on the basis of the charge/discharge current acquired by the current acquisition unit 123 from the first time to the second time. The charge/discharge amount from the first time to the second time is represented as ΔC.

The full-charge-capacity calculation unit 48 calculates the unit full charge capacity of each of the plurality of unit cells 11a on the basis of the first state of charge SOC1, the second state of charge SOC2, and the charge/discharge amount ΔC. When the unit full charge capacity is represented as F, the unit full charge capacity F can be calculated by the equation, F=ΔC/ΔSOC (where ΔSOC=SOC2-SOC1).

The state-of-health calculation unit 49 calculates a state of health, for example, by comparing the full charge capacity of the unit cell 11a calculated by the full-charge-capacity calculation unit 48 with the initial full charge capacity stored in the storage unit 43. Assuming that the present full charge capacity is FCC and the initial value of the full charge capacity is FCC_0, the state of health is represented by the following equation. The state-of-health calculation unit 49 calculates the state of health of each of the plurality of unit cells 11a.

State of health=FCC/FCC_0

Moreover, the state-of-health calculation unit 49 may calculate the state of health of each unit cell 11a on the basis of the correlation between the internal resistance increase rate and the discharge capacity ratio of each unit cell 11a stored in the storage unit 43, and an internal resistance increase rate calculated by the cell-equivalent-circuit parameter calculation unit 47.

Furthermore, the state-of-health calculation unit 49 may calculate the state of health by comparing the initial cell-equivalent parameters of each unit cell 11a stored in the storage unit 43 with the present cell-equivalent-circuit parameters.

The state information of each unit cell 11a including the state of charge, the cell equivalent circuit parameters, the full charge capacity, and the state of health calculated by the unit-cell-state calculation device 4 as described above, etc., is wirelessly transmitted to the on-vehicle control device 3 by processing of the communication processing unit 42.

The on-vehicle control device 3 receives the state information transmitted from the unit-cell-state calculation device 4, and executes a process regarding charging/discharging on the basis of the received state information. For example, the on-vehicle control device 3 determines the presence/absence of over-charge or over-discharge on the basis of the state information of each unit cell 11a, and executes a process of stopping charging/discharging as necessary. In addition, when the cell balance of each unit cell 11a is broken, the on-vehicle control device 3 controls charging/discharging of each unit cell 11a to perform cell balancing.

Moreover, the on-vehicle control device 3 transmits the received state information of each unit cell 11a to each battery monitoring device 12.

Each battery monitoring device 12 receives the state information transmitted from the on-vehicle control device 3 and stores the received state information in the battery state storage unit 12e.

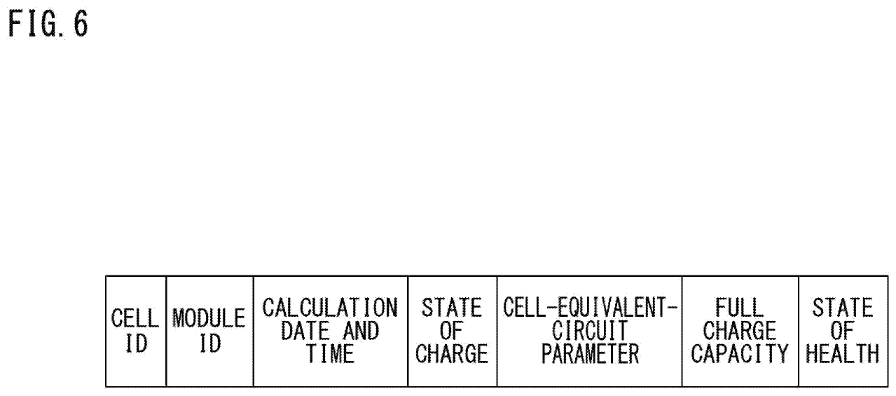

FIG. 6 is a conceptual diagram showing an example of the state information of the unit cell 11a stored in the battery state storage unit 12e. The state of charge, the cell equivalent circuit parameters, the full charge capacity, and the state of health of each unit cell 11a calculated by the state-of-charge calculation unit 46, the cell-equivalent-circuit parameter calculation unit 47, the full-charge-capacity calculation unit 48, and the state-of-health calculation unit 49 of the unit-cell-state calculation device 4 are stored in the battery state storage unit 12e so as to be associated with the cell ID identifying the unit cell 11a, the module ID identifying the battery module device 1, and information indicating the date and time of calculation of each cell information, as shown in FIG. 6.

FIG. 7 is a perspective view showing the battery monitoring devices 12 and the secondary battery 10 formed by connecting the battery module devices 1 according to Embodiment 1 in series, FIG. 8 is a perspective view showing an example of the configuration of the battery module device 1 according to Embodiment 1, and FIG. 9 is a plan view showing an example of the configuration of the battery module device 1 according to Embodiment 1.

The plurality of battery module devices 1 each have a quadrangular prism shape as a whole, as shown in FIG. 8, and have substantially the same shape. As shown in FIG. 7, the plurality of battery module devices 1 are arranged in the longitudinal direction and the lateral direction of the battery module devices 1, and the respective battery modules 11 are connected in series to form the secondary battery 10. For example, 2×5=10 battery modules 11 are arranged side by side in the longitudinal direction and the lateral direction, forming a rectangular plate shape as a whole.

The plurality of unit cells 11a included in the battery module 11 each have a plate shape, and the respective unit cells 11a are arranged so as to be stacked in the thickness direction thereof. Each unit cell 11a has a pair of electrode terminals 11b at both end portions of one side surface (the upper surface in FIG. 6 and FIG. 7), and the multiple electrode terminals 11b at each end are linearly arranged in the stacking direction.

The stacked unit cells 11a are held by a holding member 1a. The holding member 1a extends to one end side in the stacking direction to form a substantially rectangular parallelepiped portion, and a support plate 12g for supporting the battery monitoring device 12 is provided at the one surface side (the upper surface side in FIG. 8 and FIG. 9) of the substantially rectangular parallelepiped portion.

The battery monitoring device 12 includes a circuit board 12h on which the cell voltage detection circuit 12b, the temperature detection circuit 12c, the module control unit 12a, the wireless communication unit 12d, the battery state storage unit 12e, and the power supply circuit 12f are disposed. The circuit board 12h is supported by the support plate 12g so as to be substantially parallel to the one side surface on which the electrode terminals 11b of the unit cells 11a are arranged. A connection terminal 12i is provided on an appropriate portion of the circuit board 12h at the unit cell 11a side. The electrode terminals 11b of the plurality of unit cells 11a are connected to the connection terminal 12i by conductive wires 12j. Each conductive wire 12j is extended along the arrangement of the electrode terminals 11b aligned in the stacking direction, is connected at one end thereof to the one electrode terminal 11b of the unit cell 11a, and is connected at another end thereof to the connection terminal 12i. The cell voltage detection circuit 12b is electrically connected to the connection terminal 12i and is configured to detect the voltage between the electrode terminals 11b of each unit cell 11a.

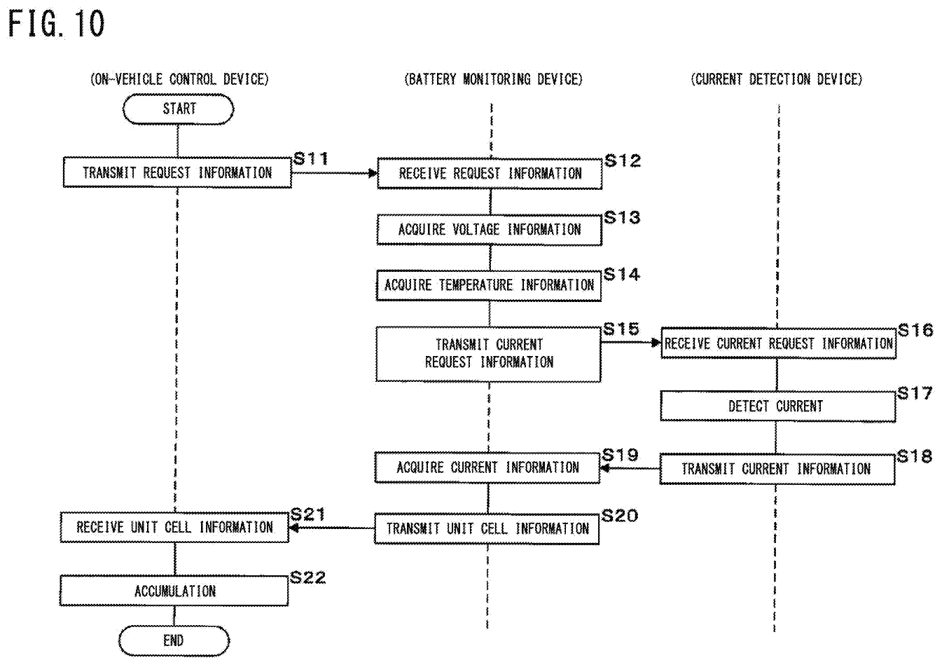

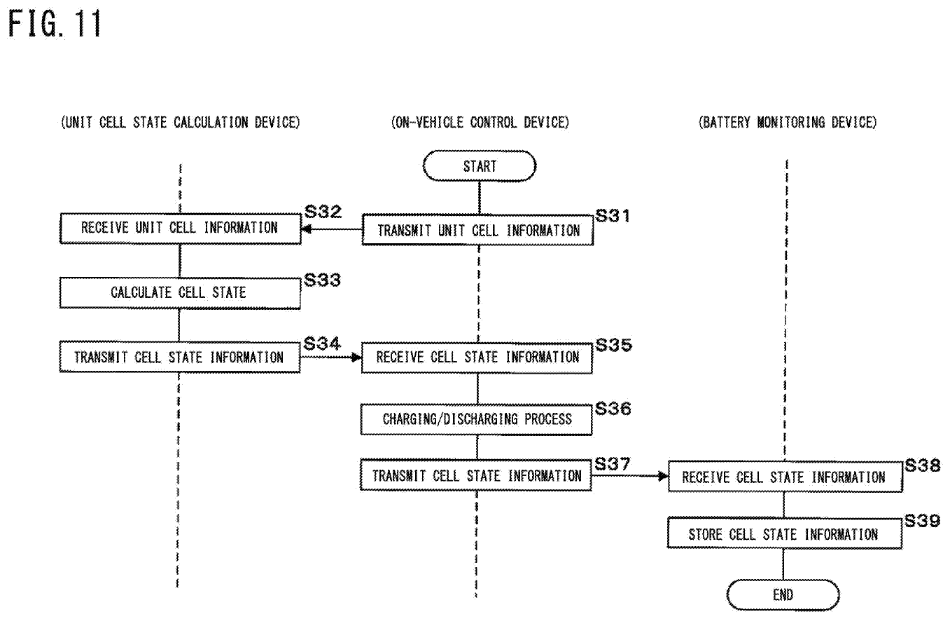

FIG. 10 and FIG. 11 are flowcharts showing a processing procedure regarding monitoring of the unit cells 11a according to Embodiment 1.

First, a process of collecting information of the voltage, the current, and the temperature of each unit cell 11a will be described with reference to FIG. 10. The on-vehicle control device 3 executes the following process in a first cycle, for example, in a 10-millisecond cycle. The on-vehicle control device 3 wirelessly transmits request information for requesting unit cell information of the voltage, the current, the temperature, etc., of each unit cell 11a, to the battery monitoring device 12 at a predetermined timing (step S11). The on-vehicle control device 3 transmits request information for each battery module device 1.

The battery monitoring device 12 receives the request information by the wireless communication unit 12d (step S12). The battery monitoring device 12 that has received the request information acquires the voltage information of each unit cell 11a included in the battery module 11 (step S13) and acquires the temperature information of each unit cell 11a (step S14). Next, the battery monitoring device 12 wirelessly transmits current request information for requesting current information, to the current detection device 2 by the wireless communication unit 12d (step S15).

The current detection device 2 receives the current request information transmitted from the battery monitoring device 12 (step S16). The current detection device 2 that has received the current request information detects the current of the secondary battery 10 (step S17) and wirelessly transmits current information obtained by the detection, to the battery monitoring device 12 (step S18).

The battery monitoring device 12 acquires the current information transmitted from the current detection device 2, via the wireless communication unit 12d (step S19). Then, the battery monitoring device 12 adds, to the unit cell information including the acquired information of the voltage between the electrode terminals 11b, the current, and the temperature of each unit cell 11a, the cell ID of the unit cell 11a and the module ID, and wirelessly transmits the unit cell information to the on-vehicle control device 3 by the wireless communication unit 12d (step S20).

The on-vehicle control device 3 receives the unit cell information transmitted from the battery monitoring device 12 (step S21), temporarily accumulates the received unit cell information (step S22), and ends the process.

Next, a process of transmitting the unit cell information of each unit cell 11a to the unit-cell-state calculation device 4, causing the unit-cell-state calculation device 4 to calculate state information of each unit cell 11a, and acquiring the state information will be described with reference to FIG. 11. The on-vehicle control device 3 executes the following process in a second cycle, for example, in a 1-minute cycle. The on-vehicle control device 3 wirelessly transmits the accumulated unit cell information to the unit-cell-state calculation device 4 (step S31).

The unit-cell-state calculation device 4 receives the unit cell information (step S32). Then, the unit-cell-state calculation device 4 calculates a cell state on the basis of the information of the voltage between the electrode terminals 11b, the current, and the temperature of each unit cell 11a included in the received unit cell information (step S33). Specifically, the unit-cell-state calculation device 4 calculates the state of charge, the cell equivalent circuit parameter, the full charge capacity, the state of health, etc., of each unit cell 11a. Next, the unit-cell-state calculation device 4 adds the on-vehicle device ID, the module ID, and the cell ID that have been added to the request information, to state information of each unit cell 11a obtained through the calculation, and wirelessly transmits the state information to the on-vehicle control device 3 (step S34).

The on-vehicle control device 3 receives the state information transmitted from the unit-cell-state calculation device 4 (step S35) and executes a process regarding charging/discharging on the basis of the received state information (step S36). For example, the on-vehicle control device 3 determines the presence/absence of over-charge or over-discharge on the basis of the state information of each unit cell 11a, and executes a process of stopping charging/discharging as necessary. In addition, when the cell balance of each unit cell 11a is broken, the on-vehicle control device 3 controls charging/discharging of each unit cell 11a to perform cell balancing.

Moreover, the on-vehicle control device 3 transmits the received state information of each unit cell 11a to the battery monitoring device 12 of the corresponding battery module device 1 on the basis of each module ID (step S37).

The battery monitoring device 12 receives the state information transmitted from the on-vehicle control device 3 (step S38) and stores the received state information in the battery state storage unit 12e (step S39).

Next, a process of outputting the state information of the unit cells 11a and a process of deleting the state information, which are executed, for example, when reusing the unit cells 11a or replacing the battery module 11, will be described.

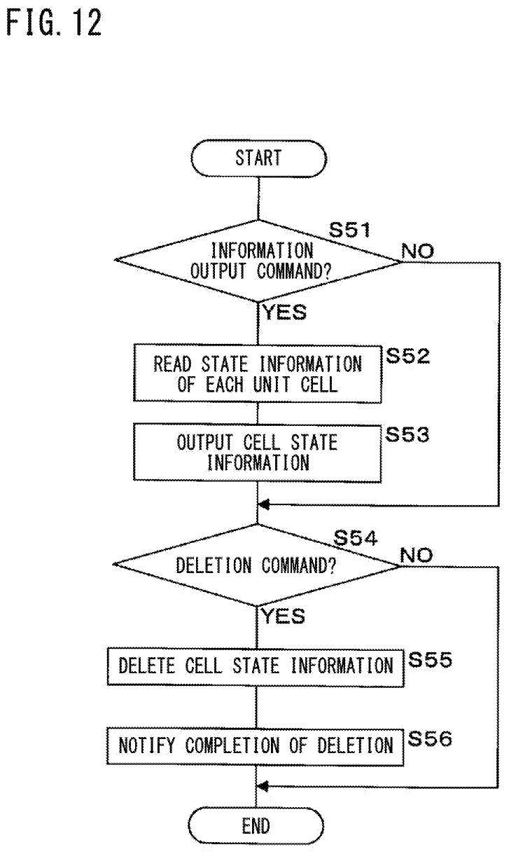

FIG. 12 is a flowchart showing a processing procedure regarding output and deletion of cell state information. The battery monitoring device 12 determines whether an information output command has been received from the outside (step S51). For example, the battery monitoring device 12 receives the information output command by the wireless communication unit 12d. A communication port that is not shown may be provided to the circuit board 12h, and the information output command may be received via the communication port. The information output command is a command for instructing output of the state information of each unit cell 11a included in the battery module 11. Upon reusing the unit cells 11a, a worker can acquire the state information of each unit cell 11a by giving the information output command to the battery monitoring device 12.

When the battery monitoring device 12 determines that the information output command has been received (step S51: YES), the battery monitoring device 12 reads the state information of each unit cell 11a from the battery state storage unit 12e (step S52) and outputs the read state information of each unit cell 11a to the outside (step S53). For example, the battery monitoring device 12 wirelessly transmits the state information to the outside by the wireless communication unit 12d. Similar to the information output command, the battery monitoring device 12 may be configured to output the state information to the outside via the communication port. The state information is associated with the cell ID of each unit cell 11a, and thus the worker can grasp the state of each of the plurality of unit cells 11a.

When the battery monitoring device 12 determines that the information output command has not been received (step S51: NO), or when the battery monitoring device 12 has completed the process in step S53, the battery monitoring device 12 determines whether a deletion command has been received (step S54). The deletion command is a command given to the battery monitoring device 12 by the worker when resetting the battery state storage unit 12e upon replacing the battery module 11.

When the battery monitoring device 12 determines that the deletion command has not been received (step S54: NO), the battery monitoring device 12 ends the process. When the battery monitoring device 12 determines that the deletion command has been received (step S54: YES), the battery monitoring device 12 deletes the information stored in the battery state storage unit 12e (step S55), sends a notification that the deletion has been completed (step S56), and ends the process. For example, the battery monitoring device 12 wirelessly transmits information indicating that the deletion of the state information has been completed, to the outside by the wireless communication unit 12d.

With the battery monitoring device 12, the battery module device 1, and the battery monitoring system configured as described above, the state of each unit cell 11a included in the secondary battery 10, which is a battery pack, can be grasped. The on-vehicle control device 3 can control charging/discharging of the secondary battery 10 while grasping the state of each unit cell 11a.

Specifically, the battery monitoring device 12 acquires the voltage, the current, and the temperature of each of the plurality of unit cells 11a, and the unit-cell-state calculation device 4 calculates the state of each unit cell 11a. Then, the unit-cell-state calculation device 4 transmits state information indicating the calculated state of each unit cell 11a, to the on-vehicle control device 3 and the battery monitoring device 12. The on-vehicle control device 3 can grasp the state of each unit cell 11a by receiving the cell state information calculated by the unit-cell-state calculation device 4.

Moreover, the battery monitoring device 12 performs wireless communication with the current detection device 2 and acquires the current information of the secondary battery 10, and thus reliability against noise can be ensured. In addition, the assemblability of the battery module device 1 and the battery monitoring system can be improved.

Furthermore, the information of the voltage, the current, and the temperature of each unit cell 11a acquired by the plurality of battery monitoring devices 12 is transmitted to the unit-cell-state calculation device 4 via the on-vehicle control device 3. Therefore, each battery monitoring device 12 does not need to perform wireless communication with the unit-cell-state calculation device 4, and the unit cell information can be efficiently transmitted wirelessly to the unit-cell-state calculation device 4.

Furthermore, the battery monitoring device 12 is configured to perform wireless communication with the on-vehicle control device 3 and transmit and receive information required for monitoring the state of each unit cell 11a, and thus reliability against noise can be ensured. In addition, the assemblability of the battery module device 1 and the battery monitoring system can be improved.

Furthermore, for example, upon reusing the unit cells 11a, the state information of each unit cell 11a can be read from the battery monitoring device 12.

Furthermore, deletion for the battery state storage unit 12e can be performed from the outside, and only the battery module 11 included in the battery module device 1 can be replaced.

Furthermore, the unit-cell-state calculation device 4 can calculate the full charge capacity, the state of charge, the state of health, and the cell equivalent circuit parameters of each unit cell 11a and wirelessly transmits the full charge capacity, the state of charge, the state of health, and the cell equivalent circuit parameters to the on-vehicle control device 3 and the battery monitoring device 12.

Furthermore, the battery monitoring device 12 and the on-vehicle control device 3 can grasp, for each battery module 11 forming a part of the secondary battery 10, the state of each unit cell 11a included in the battery module 11.

Furthermore, since each battery monitoring device 12 and each battery module 11 are unitized, when a malfunction occurs in a part of the battery modules 11 included in the secondary battery 10, the secondary battery 10 can be used again by replacing only the corresponding battery module device 1. It is not necessary to replace and repair the entire secondary battery 10, and the secondary battery 10 and the battery monitoring system having excellent maintainability can be configured.

Furthermore, the battery module 11 and the monitoring device can be made compact as shown in FIG. 8 and FIG. 9. In addition, since the monitoring device is disposed at one end side in the stacking direction of the unit cells 11a, it is easy to assemble the battery module device 1, and the battery module device 1 also has excellent maintainability. When a malfunction occurs in either the battery module 11 or the battery monitoring device 12, the battery module 11 or the battery monitoring device 12 can be easily replaced.

Furthermore, the lengths of the conductive wires 12j connecting the battery monitoring device 12 and the electrode terminals 11b of each unit cell 11a can be minimized, so that noise resistance performance can be ensured.

In the present embodiment, the example in which the battery module device 1, the current detection device 2, and the on-vehicle control device 3 wirelessly transmit and receive information has been described. However, the battery module device 1, the current detection device 2, and the on-vehicle control device 3 may transmit and receive information through wired communication.

Moreover, the example in which the plurality of unit cells 11a are connected in series to form the secondary battery 10 has been described. However, the plurality of unit cells 11a may be connected in series-parallel to form the secondary battery 10.

Furthermore, each battery module device 1 and the current detection device 2 have been described as separate devices. However, a current detection circuit 21 may be provided in one battery module device 1, and the one battery module device 1 may be configured to transmit information of the current of the secondary battery 10 to another battery module device 1.

Furthermore, the example in which the on-vehicle control device 3 directly transmits and receives information to and from each battery module device 1 has been described. However, depending on the situation, the battery module devices 1 may perform wireless communication with each other, and the on-vehicle control device 3 may perform wireless communication with another battery module device 1 via one battery module device 1. For example, when the on-vehicle control device 3 cannot perform wireless communication with the other battery module device 1 due to deterioration of the communication environment, the on-vehicle control device 3 may perform communication with the other battery module device 1 via the one battery module device 1. The same applies to current information.

### (Modifications)

In Embodiment 1 described above, the unit-cell-state calculation device 4 wirelessly transmits unit cell information of each unit cell 11a obtained through calculation, to the on-vehicle control device 3 and the battery monitoring device 12. However, the transmission destination of the unit cell information is not necessarily limited to the above devices mounted on the vehicle C.

For example, the unit-cell-state calculation device 4 stores the on-vehicle device ID of the on-vehicle control device 3 and an e-mail address of the user of the vehicle C on which the on-vehicle control device 3 is mounted, in association with each other. When the unit-cell-state calculation device 4 calculates cell state information of each unit cell 11a on the basis of unit cell information having the on-vehicle device ID added thereto, the unit-cell-state calculation device 4 may wirelessly transmit the cell state information to a terminal device of the user by using the e-mail address associated with the on-vehicle device ID.

Moreover, the unit-cell-state calculation device 4 may generate information indicating the state of the secondary battery 10 based on the state information of each unit cell 11a, for example, information indicating the presence/absence of an abnormality in the entire secondary battery 10, and may wirelessly transmit the information to the terminal device of the user.

According to the modifications, state information such as the full charge capacity, the state of charge, the state of health, and the cell equivalent circuit parameters of each unit cell 11 a can be notified to the user.

### REFERENCE SIGNS LIST

1 battery module device
1a holding member
2 current detection device
3 on-vehicle control device
4 unit-cell-state calculation device
10 secondary battery
11 battery module
11a unit cell
11b electrode terminal
12 battery monitoring device
12a module control unit
12b cell voltage detection circuit
12c temperature detection circuit
12d wireless communication unit
12e battery state storage unit
12f power supply circuit
12g support plate
12h circuit board
12i connection terminal
12j conductive wire
21 current detection circuit
22 current detection control unit
23 current information transmission unit
31 control unit of on-vehicle device
32 wireless communication unit of on-vehicle device
33 vehicle-outside wireless communication unit
41 calculation unit
42 communication processing unit
43 storage unit
44 timer
45 current integration unit
46 state-of-charge calculation unit
47 cell-equivalent-circuit parameter calculation unit
48 full-charge-capacity calculation unit
49 state-of-health calculation unit
121 control unit
122 voltage acquisition unit
123 current acquisition unit
124 temperature acquisition unit
125 communication processing unit

1. A battery monitoring method for monitoring each of a plurality of unit cells included in a secondary battery mounted on a vehicle, wherein
a battery monitoring device provided to the vehicle
acquires a voltage of each of the plurality of unit cells,
acquires a current of the secondary battery,
acquires a temperature of each of the plurality of unit cells, and
transmits unit cell information including the acquired voltage, current, and temperature and an identifier of each of the unit cells, to a state calculation device provided outside the vehicle and configured to calculate each of states of the plurality of unit cells, and
the state calculation device
receives the unit cell information transmitted from the battery monitoring device, and
calculates each of the states of the plurality of unit cells on the basis of the voltage, the current, and the temperature included in the received unit cell information.

2. A battery monitoring device configured to monitor each of a plurality of unit cells included in a secondary battery mounted on a vehicle, the battery monitoring device comprising:
a voltage acquisition unit configured to acquire a voltage of each of the plurality of unit cells;
a current acquisition unit configured to acquire a current of the secondary battery;
a temperature acquisition unit configured to acquire a temperature of each of the plurality of unit cells; and
a unit-cell-information transmission unit configured to transmit unit cell information including the voltage, the current, and the temperature acquired by the voltage acquisition unit, the current acquisition unit, and the temperature acquisition unit and an identifier of each of the unit cells, to a state calculation device configured to calculate each of states of the plurality of unit cells.

3. The battery monitoring device according to claim 2, wherein the current acquisition unit acquires the current of the secondary battery by receiving current information wirelessly transmitted from a current detection unit provided to the secondary battery.

4. A battery monitoring system comprising:
the battery monitoring device according to claim 2 configured to monitor each of the plurality of unit cells of the secondary battery mounted on the vehicle; and
the state calculation device provided outside the vehicle and configured to calculate each of the states of the plurality of unit cells, wherein
the state calculation device includes
a unit-cell-information reception unit configured to receive the unit cell information transmitted from the battery monitoring device, and
a state calculation unit configured to calculate each of the states of the plurality of unit cells on the basis of the voltage, the current, and the temperature included in the unit cell information received by the unit-cell-information reception unit.

5. The battery monitoring system according to claim 4, wherein the state calculation device includes a state information transmission unit configured to transmit state information of each of the plurality of unit cells calculated by the state calculation unit and the identifier of each of the unit cells, to the battery monitoring device or an on-vehicle control device configured to perform control regarding charging/discharging of the secondary battery.

6. The battery monitoring system according to claim 5, wherein
the on-vehicle control device includes a vehicle-outside wireless communication unit configured to perform wireless communication with the state calculation device provided outside the vehicle, and
the battery monitoring device transmits the unit cell information via the on-vehicle control device to the state calculation device.

7. The battery monitoring system according to claim 6, wherein the battery monitoring device wirelessly transmits the unit cell information of each of the plurality of unit cells to the on-vehicle control device, and transmits the unit cell information via the on-vehicle control device to the state calculation device.

8. The battery monitoring system according to claim 5, wherein the battery monitoring device includes:
a state information reception unit configured to receive the state information and the identifier transmitted from the state calculation device; and
a battery state storage unit configured to store the state information received by the state information reception unit and the identifier of each of the unit cells in association with each other.

9. The battery monitoring system according to claim 8, further comprising a deletion processing unit configured to delete the state information and the identifier stored in the battery state storage unit.

10. The battery monitoring system according to claim 4, wherein the state calculation unit calculates at least one of a full charge capacity, a state of charge, a state of health, and a cell equivalent circuit parameter of each of the plurality of unit cells.

11. The battery monitoring system according to claim 4, wherein the state calculation device transmits state information of each of the plurality of unit cells calculated by the state calculation unit or information indicating a state of the secondary battery based on the state information of each of the plurality of unit cells, to a user terminal device.

12. A battery monitoring system comprising:
the battery monitoring device according to claim 3 configured to monitor each of the plurality of unit cells of the secondary battery mounted on the vehicle; and
the state calculation device provided outside the vehicle and configured to calculate each of the states of the plurality of unit cells, wherein
the state calculation device includes
a unit-cell-information reception unit configured to receive the unit cell information transmitted from the battery monitoring device, and
a state calculation unit configured to calculate each of the states of the plurality of unit cells on the basis of the voltage, the current, and the temperature included in the unit cell information received by the unit-cell-information reception unit.

13. The battery monitoring system according to claim 12, wherein the state calculation device includes a state information transmission unit configured to transmit state information of each of the plurality of unit cells calculated by the state calculation unit and the identifier of each of the unit cells, to the battery monitoring device or an on-vehicle control device configured to perform control regarding charging/discharging of the secondary battery.

14. The battery monitoring system according to claim 13, wherein
the on-vehicle control device includes a vehicle-outside wireless communication unit configured to perform wireless communication with the state calculation device provided outside the vehicle, and
the battery monitoring device transmits the unit cell information via the on-vehicle control device to the state calculation device.

15. The battery monitoring system according to claim 14, wherein the battery monitoring device wirelessly transmits the unit cell information of each of the plurality of unit cells to the on-vehicle control device, and transmits the unit cell information via the on-vehicle control device to the state calculation device.

16. The battery monitoring system according to claim 6, wherein the battery monitoring device includes:
a state information reception unit configured to receive the state information and the identifier transmitted from the state calculation device; and
a battery state storage unit configured to store the state information received by the state information reception unit and the identifier of each of the unit cells in association with each other.

17. The battery monitoring system according to claim 7, wherein the battery monitoring device includes:
a state information reception unit configured to receive the state information and the identifier transmitted from the state calculation device; and
a battery state storage unit configured to store the state information received by the state information reception unit and the identifier of each of the unit cells in association with each other.

18. The battery monitoring system according to claim 13, wherein the battery monitoring device includes:
a state information reception unit configured to receive the state information and the identifier transmitted from the state calculation device; and
a battery state storage unit configured to store the state information received by the state information reception unit and the identifier of each of the unit cells in association with each other.

19. The battery monitoring system according to claim 14, wherein the battery monitoring device includes:
a state information reception unit configured to receive the state information and the identifier transmitted from the state calculation device; and
a battery state storage unit configured to store the state information received by the state information reception unit and the identifier of each of the unit cells in association with each other.

20. The battery monitoring system according to claim 15, wherein the battery monitoring device includes:
a state information reception unit configured to receive the state information and the identifier transmitted from the state calculation device; and
a battery state storage unit configured to store the state information received by the state information reception unit and the identifier of each of the unit cells in association with each other.

21. The battery monitoring system according to claim 16, further comprising a deletion processing unit configured to delete the state information and the identifier stored in the battery state storage unit.

22. The battery monitoring system according to claim 17, further comprising a deletion processing unit configured to delete the state information and the identifier stored in the battery state storage unit.

23. The battery monitoring system according to claim 18, further comprising a deletion processing unit configured to delete the state information and the identifier stored in the battery state storage unit.

24. The battery monitoring system according to claim 19, further comprising a deletion processing unit configured to delete the state information and the identifier stored in the battery state storage unit.

25. The battery monitoring system according to claim 20, further comprising a deletion processing unit configured to delete the state information and the identifier stored in the battery state storage unit.

26. The battery monitoring system according to claim 12, wherein the state calculation unit calculates at least one of a full charge capacity, a state of charge, a state of health, and a cell equivalent circuit parameter of each of the plurality of unit cells.

27. The battery monitoring system according to claim 12, wherein the state calculation device transmits state information of each of the plurality of unit cells calculated by the state calculation unit or information indicating a state of the secondary battery based on the state information of each of the plurality of unit cells, to a user terminal device.
